(19) United States
(12) Patent Application Publication
(10) Pub. No.: US 2011/0161062 A1
(43) Pub. Date: Jun. 30, 2011

(54) METHOD AND DEVICE FOR DECONTAMINATING A METALLIC SURFACE

(75) Inventors: Caroline Paulus, Grenoble (FR); Laurent Gerfault, Tullins (FR); Pierre Grangeat, Saint Ismier (FR)

(73) Assignee: COMM.A L'ENER. ATOM. ET AUX ENERGIES ALT, PARIS (FR)

(21) Appl. No.: 13/060,943

(22) PCT Filed: Sep. 4, 2009
(86) PCT No.: PCT/EP09/61484

§ 371 Date: Feb. 25, 2011

(30) Foreign Application Priority Data
Sep. 5, 2008 (FR) 0855979
May 29, 2009 (FR) 0953579

(51) Int. Cl. G06G 7/58; G01N 30/02

(52) U.S. Cl. 703/11; 73/61.53

(57) ABSTRACT

A model of evolution of a signal of a chromatographic column is formed, then inversed as a function of the measured signals, to calculate solute concentrations by using the entire signal. The model is based on equations that govern the transport of solutes in the column as a function of various physical parameters, which can be re-evaluated. The method can be used for searching and measuring rare components, such as proteins, in liquid biological samples.

### TECHNICAL FIELD

The invention relates to a method for determining concentrations of molecular species on a chromatogram.

Resort is often made to separation techniques for the analysis of mixtures. The different apparatus may comprise a chromatographic column that can be coupled to a mass spectrometer. In the particular case of biological fluids where it is sought to measure the concentration of different proteins, a digestion module may be added upstream to decompose the proteins into peptides, the study of which is easier. Chromatographic columns are based on the different velocities taken by the chemical species of a mixture to travel through the column and their consecutive separation. A measured spectrogram is a signal in two dimensions corresponding to the output of the mass spectrometer. One of the dimensions is sensitive to the retention time of the different species in the chromatographic column, the other dimension corresponds to the mass over charge ratio associated with each of the species. This data consists in a spectrum composed of a succession of peaks. By projecting the spectrogram onto the retention time dimension or by making a cut off at a given mass, a measured chromatogram is obtained, namely an image of the output signal of the chromatographic column. The study of the spectrogram or the chromatogram makes it possible to determine the chemical species of the mixture and their concentrations.

It must however be admitted that precise results are difficult to obtain, particularly for two reasons. The surface area of the peaks, which expresses the concentration of the chemical species concerned, may be difficult to evaluate on account of the noise of the apparatus or the fluctuation of the physical parameters of the chromatography column; also, the shape and the position of the peaks can vary from one experiment to the next due to different characteristics of the chromatographic columns, different measurement conditions or a simple statistical dispersion. These drawbacks are all the more pronounced when the chemical species are numerous and their concentrations very low, which is the case of proteins in biological liquids, where often certain rare proteins are searched for. This is for example the case of cancer blood markers, which are found in the plasma at concentrations of the order of 1 to 1000 picomoles/litre, or 1 to 1000 femtomoles per millilitre of plasma.

Among known methods, the most simple of them consists in isolating each peak, evaluating the concentration by measurements of their height over the corresponding elution time (along the axis of the chromatogram) or even by a single height measurement, and determining what chemical species is involved according to the position of the peak on the spectrogram. The aforementioned imprecision drawbacks of the result obtained and even the difficulty of identifying correctly the chemical species in the presence of complex mixtures are particularly pronounced in this rudimentary method.

Another method consists in using a numerical breakdown of the spectrogram by a factorial analysis to isolate the peaks. The peaks of the peptides of interest are obtained from calibrations of samples of known compositions. But the conventional drawbacks are not sufficiently eliminated, for example due to disparities between the measurement conditions at the calibration and the study of the sample, which are difficult to evaluate and correct. The article of Forssén et al. “An improved algorithm for solving inverse problems in liquid chromatography”, which appeared in Computer & Chemical Engineering (Elsevier), vol. 30, no 9, is a variant of this method in which the elution peaks are obtained by simulation from isotherm equations (bringing into relation the mobile phase and the stationary phase of a solute in a chromatographic column); these equations are also used in the envisaged embodiments of the invention to construct the model, but the prior art advocates making the simulated peaks and the experimental peaks coincide by an adjustment of the modelling parameters thereof, which can give difficulties of convergence in the case of a large number of solutes, the parameters of which must be adjusted more or less independently, whereas it is difficult to take good account of inaccuracies in the measurement or the estimation of parameters. The article “An improved algorithm for solving inverse chromatography” by Jakobsson et al., Journal of Chromatography A (Elsevier), vol. 1063, discloses a similar factorial analysis method with the use of a model to simulate the elution peaks independently.

The invention relates to an improved method for determining concentrations of molecular species in a solution passed through a chromatographic column and a mass spectrometer. Solution is taken to mean a homogeneous mixture, having a single phase, of two or several bodies. It is based on the use of a theoretical local spatio-temporal model of the transport of molecules through the chromatographic column to express modelled chromatograms each associated with one of the species, more precise than with an empirical calibration. In addition, the model is expressed in the form of a state-space representation, the general form of which will be recalled in the detailed description. State-space representations are employed particularly automatically to predict the evolution of physical systems according to the commands introduced therein; they are adopted here since they allow an inversion of the system of equations comprising the results and the parameters of the model in quite a simple and direct manner to distinguish on the chromatogram the contributions of the different chemical species that make up the sample, and finally to deduce their respective concentrations.

Since a rigorous model is used to express the modelled chromatograms, a better identification of the peaks of the chromatogram of study could be expected, thus a better evaluation of the composition of the sample, and a better evaluation of the concentrations, especially since the inversion of the system is performed in a simple manner. Another important consideration is that the physical parameters of the measurement apparatus being all related to the experimental results in the equations deriving from the model, these are resolved numerically with the faculty of varying these physical parameters in addition to the unknowns (the concentrations to determine of the solutes) in order to obtain a better resolution, by thus probably correcting inaccuracies made beforehand in estimating them or measuring them.

The transport model of molecules expressing the modelled chromatograms may comprise, for each of the species, an evolution equation of concentrations of the molecules of said species, along the chromatographic column, with time. This equation stems directly from the chemical reactions of adsorption and desorption of the molecules on the solid material of the column, which obey simple and known laws.

This evolution equation may favourably express the concentration at each point of the chromatographic column as a function of prior concentrations at this point and at neighbouring points, by a simple combination weighted by coefficients.

These coefficients may be determined analytically or empirically. They are functions of parameters comprising in particular parameters of the chromatographic column, parameters of the calibration chromatographic peaks and adjustment parameters.

The parameters of the chromatographic column may comprise a length and a parameter that is a function of its porosity. The parameters of the calibration chromatographic peaks may comprise one or more parameters of the position of the peaks and the shape of the peaks, determined empirically by a calibration.

The adjustment parameters may comprise spatial, along the chromatographic column, and temporal sampling intervals.

Other parameters may be added to the model, such as a velocity of a solvent in the chromatographic column or parameters describing a modification of composition of a solvent with time, when the chromatography is conducted for example in gradient mode, with a progressive introduction of a stronger solvent than the solvent used originally.

The invention will now be described by two main embodiments: a mode known as isocratic where the composition of the solvent responsible for the movement of the sample through a chromatography column remains constant, and a mode known as gradient where the composition of the solvent changes, a stronger solvent progressively replacing an initial solvent.

The invention will now be described with reference to the figures:

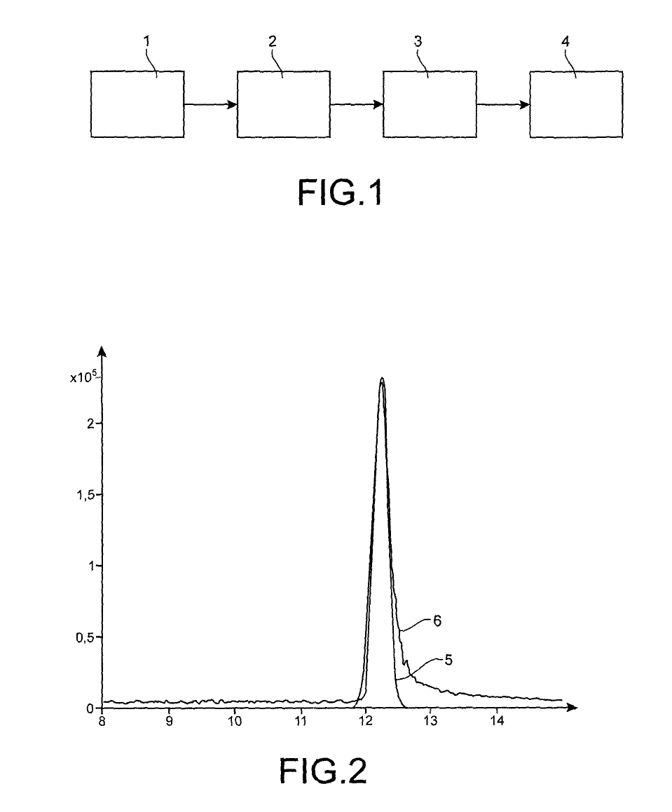

FIG. 1 represents an instrumentation,

FIG. 2 a measured chromatogram signal and a modelled chromatogram signal,

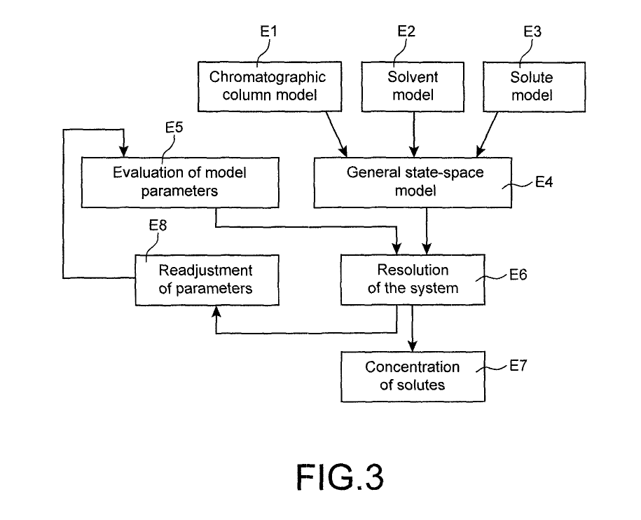

and FIG. 3 is a logic diagram of the method.

The operating device may be that of FIG. 1, where a blood sample to be studied, for example, passes through a digestion module 1 which breaks down the proteins into peptides, the measurement and the study of which are easier, then through the chromatography column 2 and through a mass spectrometer 3. The signal then emitted is a two dimensional spectrogram; it is supplied to a processing module 4 which uses the method of exploiting the spectrum, constituting the invention, to deduce from this the concentrations of the peptides of the sample. As described previously, it is then possible to establish a chromatogram of the sample by making the projection of the spectrogram onto the retention time dimension or by making a cut off at a given mass. But the invention naturally applies to a chromatogram directly measured at the output of the chromatography column.

The invention may be applied with other devices. It is thus that an enrichment module, which may comprise stages of depletion or capture by affinity, upstream of the digestion module, may be added to perform a first selection of the proteins of interest. Also, the digestion module 1 is optional: the signal arriving at the processing module 4 could be analogue but representative of proteins rather than peptides, so that the invention could be applied without change to give the concentrations of said proteins. The mass spectrometer 3 may have different operating modes, this not influencing the processings of the module 4. The conventional mode called MS mode (Mass Spectrometry), where a range of masses is studied, may be replaced by the MS-MS mode where a refractionation of peptides of certain masses is carried out or instead the MRM mode (Multiple Reaction Monitoring) where the analysis is made for only several predefined masses. Finally, the mass spectrometer 3 is itself also optional, and the signal from the chromatograph 2 and processed by the processing module 4 could be a single dimensional spectrum that could be processed in the same manner.

The invention could also be applied to other types of samples or products to be measured.

The processing module 4 works by performing a numerical inversion of the signal that it receives to give the concentrations of peptides or, in general, products measured by the device. It is based on a modelling of the signal as a function of the different parameters, of which said concentrations and other parameters, known by a calibration or another measurement, or unknowns.

FIG. 3 gives a general representation of the method. Models of the chromatographic column 2 (E1), of the solvent (E2) and of the solute (E3) are elaborated to describe the flow in the chromatographic column 2, the adsorption of the solute by said column and the law of supply of the solvent. The synthesis of these particular models gives a general state-space model (E4) which completely describes the signal stemming from the chromatographic column 2 as a function of various parameters, which can be evaluated (E5) by specific calibrations, measurements, hypotheses, or which depend on arbitrary choices. When a measurement has been made on an unknown fluid, giving an experimental chromatogram, it may enter in the writing of a system where it corresponds to the model weighted by the parameters. The resolution of this system (E6) by numerical inversion gives the concentrations of the solutes (E7) of the unknown fluid. The parameters may nevertheless be readjusted (E8), the resolution generally being iterative.

The steps of the method will be detailed more or less in the order of their presentation. Complements and generalisations will be given as the opportunity arises.

How the numerical model of the signal is created will now be described.

### Parameters of the Model

1) A component of the model ensues from the progressive transport of solutes such as proteins in the chromatographic column. The transport may be represented by the equation (1) below, which gives the concentration of the solute adsorbed q on the stationary phase (ion exchange resin) of the column compared to the concentration of the solute in the mobile phase c at the same spot (abscissa z) and at the same instant (t):

$$\frac{\partial c ( z , t )}{\partial t} + F \frac{\partial q ( z , t )}{\partial z} + {u}_{s} \frac{\partial c ( z , t )}{\partial z} = Di \frac{{\partial }^{2} c ( z , t )}{\partial {z}^{2}} \qquad ( 7 )$$

where F is the ratio of the volumes occupied by the mobile phase and the stationary phase (porosity factor), uₛ the rate of propagation of the solvent, and Dᵢ a factor representing the dispersion that contributes to the spreading out of the chromatography peaks (called diffusion factor).

2) Another characteristic of the state of the chromatographic column concerns the adsorption of the solute on the stationary phase of the column, in other words the interaction of the molecules of the mobile phase with the stationary phase. A modelling may be carried out, for example for a stationary regime, which is called isotherm, at equilibrium. An example of simple isotherm is q*=k.c*, the asterisks indicating that the concentrations are considered at equilibrium, and k being a constant factor, known as reaction yield. An example of linear isotherm may be noted q(z,t)=k.c(z,t) (2).

3) In the case of a gradient mode, modelling the evolution of the concentration of the solvents is again advisable. In typical experiments, the weak solvent is water, and initially preponderant or even unique (100% of the total concentration in the solution); and the strong solvent φ is methanol or acetonitrile, which is introduced progressively. In the most simple case, there is no interaction between the solvent and the stationary phase, and the injection front of the solvent is identical (in flow rate and in composition) from the start to the end of the column except for a propagation delay. A linear variation of the concentration φ of the strong solvent φ may be considered, between 0 at an instant t₁ and a maximum value at a later instant t_{2,} i.e. (φ(t,z=0)=φ₀+βt), and at any point of the reaction the following is obtained:

$$\begin{matrix}ϕ ( t , z ) = {ϕ}_{0} & for 0 < t < z / {u}_{s} \\ j ( t , z ) = j 0 + b ( t - \frac{z}{{u}_{s}} ) & for z / {u}_{s} < t .\end{matrix}$$

4) The behaviour of the solute will now be considered. In isocratic mode (constant composition of the solvent), the retention factor k introduced in 2) is defined as k=(t_{R}−t₀)/Ft₀, where t₀ is the dead time or retention time of the column to get out the non retained compounds, t_{R} is the retention time of the solute considered, and F is the porosity parameter, seen in 1, of the stationary phase and independent of the solvent. In gradient mode, k is a function of φ and a relation such that ln k(φ)=ln k_{w}−S.φ, k_{w} being the retention factor in water and S the slope of the gradient is commonly used.

5) More complex models could be taken into account as well as certain chromatographic columns comprising stationary phases in polar pillars. Liquid is then found almost immobile and forms a stagnant phase. The transfers of solute may take place between the mobile phase and the stationary phase, the stagnant phase and the stationary phase, and the mobile phase and the stagnant phase. The molecular diffusion could consist in being an axial diffusion in the mobile phase. Non linear isotherms can again be introduced to take account of the variation often observed in the efficiency of the exchange according to the concentrations of solute in the mobile phase and the stationary phase. Finally, compared to equation (2), a non linear isotherm or instead an isotherm linking the solute and the solvent in the case of interaction between the solvent and the stationary phase could be proposed. A description of a non linear isotherm may be found in the work “Fundamentals of preparative and nonlinear chromatography” chapters 3 and 4 (authors: Guiochon et al., Elsevier Academic Press—second edition), and another description in the article “Mass loadability of chromatographic columns”, by Poppe and Kraak, which appeared in the “Journal of Chromatography”, 255 (1983), p. 395 to 414, Elsevier Scientific Publishing Company. Finally, non linear isotherms as determined in the document “An improved algorithm for solving inverse problems in liquid chromatography” by P. Forssén, which appeared in Computers and Chemical Engineering, 2006, pages 1381-1391, may be used.

### Influence of the Internal Calibration

In the remainder of the method, weighted proteins in the sample will be considered. These are calibration proteins commonly used in the prior art to take account of variations in results of the chromatographic column, particularly the retention time of the compounds of the samples. These weighted proteins are almost identical to the proteins searched for but are enriched in heavy isotopes and thus easily identifiable in the mass spectrometer 3. Introduced at known concentrations, they make it possible to calibrate the chromatographic column by measuring the heights and the retention times of their peaks, to the benefit of the measurements of study proteins of same species. It should nevertheless be underlined that the use of weighted proteins is not obligatory in practice.

m_{i,j,k}⁽ⁿ⁾ designates the chromatogram of the peptide i belonging to a study protein k in the sample j at the time n, m*_{i,j,k}⁽ⁿ⁾ the same chromatogram but for the peptide belonging to the weighted protein k, mⱼₖ (n) the sum of the chromatograms of the Nₚₑₚ peptides belonging to the study protein k, m*_{j,k}(n) the same sum for the weighted protein k, i.e.

$${m}_{j , k} ( n ) = {\sum }_{i = 1}^{Npep} {m}_{i , j , k} ( n ) and {m}_{j , k}^{*} ( n ) = {\sum }_{i = 1}^{Npep} {m}_{i , j , k}^{*} ( n ) , \\ and {m}_{i , j , k}^{( n )} and {m}_{i , j , k}^{* ( n )}$$

may be expressed by:

m_{i,j,k}(n)=α_{i,k}β_{i,j,k}y_{i,k}(n,p)c_{j,k}+ε_{i,j,k}(n)

m*_{i,j,k}(n)=β_{i,j,k}y_{i,k}(n,p)c*_{j,k}+ε*_{i,j,k}(n)

where c_{j,k} is the concentration of the study protein k in the sample j, c*_{j,k} the concentration of the weighted protein k, β_{i,j,k} the calibration gain of the measurement chain for the peptide i of the protein k (obtained thanks to the known concentration c*_{j,k}, of the operator and the corresponding measurement on the signal), α_{i,k} is a calibration gain (obtained by using an external calibration for a sample of proteins at the known concentration c_{j,k}), y_{i,k}(n,p) is the response of the chromatograph 2 for the peptide i belonging to the protein k, according to the state model indicated below and ε_{i,j,k} and ε*_{i,j,k} are noises, that it is possible to model independently, for example by carrying out a zero mean Gaussian random process (corresponding to a white noise) and of determined variance. These noises are for example noises due to the random nature of interactions in the chemical reactions. They may also be electronic noises. p corresponds to all of the parameters of the model: it may be physical parameters specific to the column or specific to the couples (column—peptide), known or determined experimentally. p also comprises numerical parameters chosen to ensure the stability of the model. These parameters will be defined in the remainder of the text.

It is assumed to have Nc calibration experiments for which c_{j,k} and c*_{j,k} are known and Np study experiments for which c*_{j,k} are known and c_{j,k} (the concentrations to be obtained) are unknown.

### Expression of the Model of the Column

The first order and second order derivatives of the equation (1) encountered above may be given by the equations (3) and (4):

$$\begin{matrix}{\frac{\partial c ( z , t )}{\partial z} \vert}_{i , n} = \frac{1}{2 Δ z} [ c ( i + 1 , n ) - c ( i - 1 , n ) ] + o ( Δ {z}^{2} ) & ( 3 ) \\ {\frac{{\partial }^{2} c ( z , t )}{\partial {z}^{2}} \vert}_{i , n} = \frac{1}{Δ {z}^{2}} [ c ( i + 1 , n ) - 2 c ( i , n ) + c ( i - 1 , n ) ] + o ( Δ {z}^{2} ) & ( 4 )\end{matrix}$$

in terms of finite differences, where Δz is the sampling interval in distance and o(Δz²) designates insignificant terms, representing the residues appearing during the approximation of a derivative by a finite difference.

In addition, the temporal derivative of the first order may be approached by the equation (5)

$${\frac{\partial c ( z , t )}{\partial t} \vert}_{i , n} = \frac{1}{Δ t} [ c ( i , n + 1 ) - c ( i , n ) ] + o ( Δ t )$$

in terms of finite differences, where Δt is the sampling interval in time and o(Δt) designates insignificant terms.
It is then possible to replace equation (1) by equation (6):

$$c ( i , n + 1 ) = I ( p ) c ( i + 1 , n ) + J ( p ) c ( i , n ) + K ( p ) c ( i - 1 , n ) \\ where \\ I ( p ) = [ \frac{Δ t ( 2 {D}_{i} - {u}_{s} Δ z )}{2 Δ {z}^{2} ( 1 + Fk )} ] , J ( p ) = [ \frac{Δ {z}^{2} ( 1 + Fk ) - 2 {D}_{i} Δ t}{Δ {z}^{2} ( 1 + Fk )} ] , \\ K ( p ) = [ \frac{Δ t ( 2 {D}_{i} + {u}_{s} Δ z )}{2 Δ {z}^{2} ( 1 + Fk )} ] ; \qquad ( 6 ) ,$$

### Developed Writing of the Model

1) The isocratic mode will firstly be considered. The model may be represented by the state-space system:

$$\{ \begin{matrix}x ( t + 1 ) = f ( x ( t ) , p , u , t ) \\ y ( t ) = h ( x ( t ) , p , u , t ) \\ x ( 0 ) = {x}_{0} ( p )\end{matrix}$$

where x(t) is a state vector, p represents the physical parameters of the system, u represents the input signal in the system (the injection function), y(t) the output of the system (model of the chromatographic column for a given peptide to be estimated) and x₀ the initial conditions of the state vector. The fact of representing the model according to a state-space system makes it possible to end up with a standard form of dynamic model, which can be resolved using existing tools. The function f is called function of the evolution of the state, whereas the function h is called observation function. In the case of a discrete, stationary and linear system, this system becomes:

$$\{ \begin{matrix}x ( n + 1 ) = A ( p ) x ( n ) + B ( p ) u ( n ) \\ y ( n ) = C ( p ) x ( n ) + D ( p ) u ( n ) \\ x ( 0 ) = {x}_{0} ( p )\end{matrix}$$

where n correspond to a time sampling from 1 to nt, A is a state matrix, B an input matrix, C an output matrix and D a direct command matrix.

The system may be developed as follows:

$$x ( n ) = ( \begin{matrix}c ( 1 , n ) \\ ⋮ \\ c ( i , n ) \\ ⋮ \\ c ( \frac{L}{Δ z} , n )\end{matrix} )$$

is a column-vector of dimension

$$nz = \frac{L}{Δ Z} ;$$

$$A ( p ) = ( \begin{matrix}J ( p ) & I ( p ) & 0 & & … & & … & & 0 \\ K ( p ) & J ( p ) & I ( p ) & 0 & & & & & ⋮ \\ 0 & ⋱ & ⋱ & ⋱ & & & & & ⋮ \\ & & ⋱ & ⋱ & ⋱ & & & & \\ ⋮ & & & K ( p ) & J ( p ) & I ( p ) & & & ⋮ \\ & & & & ⋱ & ⋱ & ⋱ & & \\ ⋮ & & & & & ⋱ & ⋱ & ⋱ & 0 \\ & & & & & 0 & K ( p ) & J ( p ) & I ( p ) \\ 0 & & … & & … & & 0 & K ( p ) & J ( p )\end{matrix} )$$

is a square matrix of dimensions nz; I(p), J(p) and K(p) must be positive so that the system is stable, which implies constraints on the sampling intervals in time and space.

$$B ( p ) = ( \begin{matrix}1 \\ 0 \\ ⋮ \\ 0\end{matrix} )$$

is a column-vector of dimension nz; C(p)=(0 . . . 0 1) is a line-vector of dimension nz, with

$$y ( n ) = c ( \frac{L}{Δ z} , n ) ;$$

D(p) is here a matrix that may be chosen at will, or be zero, which is assumed here.

2) It will now be seen how the state-space system is formed in gradient mode. It becomes:

$$\{ \begin{matrix}x ( n + 1 ) = A ( n , p ) x ( n ) + B ( n , p ) u ( n ) \\ y ( n ) = C ( n , p ) x ( n ) + D ( n , p ) u ( n ) \\ x ( 0 ) = {x}_{0} ( p )\end{matrix}$$

which differs from the preceding in that the matrices A,B,C and D depend on the time n. The isotherm may then be defined by the relation (7), and the gradient by the relations (8) and (9) below for the given hypotheses of a linear gradient,

$$\begin{matrix}q ( z , t ) = k ( z , t ) c ( z , t ) & ( 7 ) \\ ln k ( z , t ) = ln {k}_{w} - S ϕ ( z , t ) ⇒ k ( z , t ) = {k}_{w} {e}^{- S ϕ ( z , t )} & ( 8 ) \\ ϕ ( z , t ) = ϕ ( 0 , t - \frac{z}{{u}_{s}} ) & ( 9 )\end{matrix}$$

The derivative of the equation (7) gives the equation (10):

$$\begin{matrix}\begin{matrix} \frac{\partial q ( z , t )}{\partial t} = k ( z , t ) \frac{\partial c ( z , t )}{\partial t} + \frac{\partial k ( z , t )}{\partial t} c ( z , t ) \\ = {k}_{w} {e}^{- S ϕ ( z , t )} \frac{\partial c ( z , t )}{\partial t} - {Sk}_{w} \frac{\partial ϕ ( z , t )}{\partial t} {e}^{- S ϕ ( z , t )} c ( z , t ) ,\end{matrix} \\ and the equation & ( 10 ) \\ ( 1 + {Fk}_{w} {e}^{- S ϕ ( z , t )} ) \frac{\partial c ( z , t )}{\partial t} - {SFk}_{w} \frac{\partial ϕ ( z , t )}{\partial t} {e}^{- S ϕ ( z , t )} c ( z , t ) + {u}_{s} \frac{\partial c ( z , t )}{\partial z} = {D}_{i} \frac{{\partial }^{2} c ( z , t )}{\partial z} & ( 11 )\end{matrix}$$

is obtained from equations (1), (8) and (10). Expressed in the form of finite differences, it becomes the equation (12):

$$\begin{matrix}( 1 + {Fk}_{w} {e}^{- S ϕ ( i , n )} ) \frac{1}{Δ t} ( c ( i , n + 1 ) - c ( i , n ) ) - {FSk}_{w} \frac{\partial ϕ ( z , t )}{\partial t} {\vert}_{i , n} {e}^{- S ϕ ( i , n )} c ( i , n ) = - \frac{{u}_{s}}{2 Δ z} ( c ( i + 1 , n ) - c ( i - 1 , n ) ) + \frac{{D}_{i}}{Δ {z}^{2}} ( c ( i + 1 , n ) - 2 c ( i , n ) + c ( i - 1 , n ) ) & ( 12 ) \\ c ( i , n + 1 ) = Δ {t ( 1 + {Fk}_{w} {e}^{- S ϕ ( i , n )} )}^{- 1} [ \frac{{D}_{i}}{Δ {z}^{2}} - \frac{{u}_{s}}{2 Δ z} ] c ( i + 1 , n ) + Δ {t ( 1 + {Fk}_{w} {e}^{- S ϕ ( i , n )} )}^{- 1} [ \frac{( 1 + {Fk}_{w} {e}^{- S ϕ ( i , n )} )}{Δ t} + {FSk}_{w} \frac{\partial ϕ ( z , t )}{\partial t} {\vert}_{i , n} {e}^{- S ϕ ( z , t )} - \frac{2 {D}_{i}}{Δ {z}^{2}} ] c ( i , n ) + Δ {t ( 1 + {Fk}_{w} {e}^{- S ϕ ( i , n )} )}^{- 1} [ \frac{{D}_{i}}{Δ {z}^{2}} + \frac{{u}_{s}}{2 Δ z} ] c ( i - 1 , n ) & \end{matrix}$$

which it is possible to express in a simplified manner by the equation (13):

c(i,n+1)=I(i,n,p)c(i+1,n)+J(i,n,p)c(i,n)+K(i,n,p)c(i−1,n) (13)

where the coefficients I, J and K have a more complicated form than previously:

$$I ( i , n , p ) = Δ {t ( 1 + {Fk}_{w} {e}^{- S ϕ ( i , n )} )}^{- 1} [ \frac{{D}_{i}}{Δ {z}^{2}} - \frac{{u}_{s}}{2 Δ z} ] , \\ K ( i , n , p ) = Δ {t ( 1 + {Fk}_{w} {e}^{- S ϕ ( i , n )} )}^{- 1} [ \frac{{D}_{i}}{Δ {z}^{2}} + \frac{{u}_{s}}{2 Δ z} ] , \\ J ( i , n , p ) = Δ {t ( 1 + {Fk}_{w} {e}^{- S ϕ ( i , n )} )}^{- 1} [ \frac{( 1 + {Fk}_{w} {e}^{- S ϕ ( i , n )} )}{Δ t} + {FSk}_{w} \frac{\partial ϕ ( z , t )}{\partial t} {\vert}_{i , n} {e}^{- S ϕ ( z , t )} - \frac{2 {D}_{i}}{Δ {z}^{2}} ]$$

The problem then has the form of the following system:

$$\{ \begin{matrix}x ( n + 1 ) = A ( n , p ) x ( n ) + B ( p ) u ( n ) \\ y ( n ) = C ( p ) x ( n ) \\ x ( 0 ) = {x}_{0} ( p )\end{matrix}$$

where x,B,C and D are identical to those of the isocratic mode and where A is expressed in the following manner:

$$A ( n , p ) = ( \begin{matrix}J ( 1 , n , p ) & I ( 1 , n , p ) & 0 & & … & & … & & 0 \\ K ( 2 , n , p ) & J ( 2 , n , p ) & I ( 2 , n , p ) & 0 & & & & & \\ 0 & ⋱ & ⋱ & ⋱ & & & & & ⋮ \\ & & ⋱ & ⋱ & ⋱ & & & & \\ ⋮ & & & K ( i , n , p ) & J ( i , n , p ) & I ( i , n , p ) & & & ⋮ \\ & & & & ⋱ & ⋱ & ⋱ & & \\ ⋮ & & & & & ⋱ & ⋱ & ⋱ & 0 \\ & & & & & 0 & K ( {n}_{z} - 1 , n , p ) & J ( {n}_{z} - 1 , n , p ) & I ( {n}_{z} - 1 , n , p ) \\ 0 & & … & & … & & 0 & K ( {n}_{z} , n , p ) & J ( {n}_{z} , n , p )\end{matrix} )$$

In all cases, from this y(n) is deduced for n=1 to n=nt, nt being the maximum abscissa of the chromatogram (number of points in retention time) in other words a state model of the output signal of the chromatographic column for a given peptide for the mode considered (isocratic or gradient). This model is typically that of an elution peak. It is a function of time and also depends on physical factors of the instrumentation. It is assumed to reproduce the signal which would be effectively measured at the output of the chromatography column 2 for this peptide under the same measurement conditions. It bears the reference 5 in FIG. 2.

### First Evaluation of Parameters

How the physical parameters p are determined will now be described. Three categories may be distinguished: some are fixed parameters that it is possible to determine by measurement such as L, length of the column, and F, phase ratio coefficient, correlated with the porosity ε of the chromatographic column by the relation

$$F = \frac{( 1 - ∈ )}{∈} .$$

A second category of parameters is determined experimentally on an experimental chromatogram: this is the velocity of the solvent uₛ, by measuring the retention time t₀ of a marker without interaction with the stationary phase and by applying simply the relation:

$${u}_{s} = \frac{L}{{t}_{0}} ;$$

likewise

$$k = \frac{{t}_{R} - {t}_{0}}{{Ft}_{0}} and {D}_{i} = \frac{{Lu}_{s} {σ}^{2}}{2 {t}_{R}^{2}} ,$$

where t_{R} and σ² represent respectively the retention time and the statistical variance (representing the spreading out) of the peptide peak in a chromatogram. This involves a case of a linear isotherm. In the case of a non linear isotherm, other parameters defining said isotherm may be taken into account: they may be concentrations of peptides, but also constituents of the solvent.

Finally, the parameters Δt and Δz of the third category are sampling intervals in time and in length, chosen arbitrarily to respect the resolution stability constraints of the numerical system.

In gradient mode, other categories of parameters must be considered. Certain parameters serve firstly to model the concentration of the strong solvent as a function of time but they are known since this concentration depends on the operator. The coefficients k_{w} and S are determined by additional calibrations bringing into play a determined peptide.

### Resolution of the System and Obtaining Results

Successive searches for minima of error functions are now carried out to inverse the complex system expressing the signal as a function of the parameters of the modelling and unknowns. In addition, in the case where the system is easy to reproduce from one experiment to the next, it is possible to readjust the parameters found beforehand to give better results. It should be noted that rather than a deterministic minimisation algorithm, such as a minimisation quadratic, it is possible to use other fit criteria between the measurements and the model such as Bayesian type stochastic minimisation algorithms.

1) The calibration factors αi,k and βi,j,k, expressing the gain of the instrumentation must now be determined. One begins by estimating the factors (βi,j,k) for each experiment (study experiment or calibration experiment) by a calculation in which both the physical parameters p and these calibration factors β_{i,j,k} are adjusted to search for a minimum, i.e.

$${min}_{{β}_{i , j , k} , p} {‖ {m}_{i , j , k}^{*} - {β}_{i , j , k} {y}_{i , k} ( p ) {c}_{j , k}^{*} ‖}^{2} + λ {‖ p - {p}_{0} ‖}^{2}$$

where m*_{i,j,k} are the measured values of the spectrograms of calibration samples comprising weighted peptides, C*_{j,k} the known concentrations of these peptides, and y_{i,k}(p) correspond to the developed writing of the model as a function of x, A, B, C, and D; λ is an arbitrary minimisation coefficient and p₀ is an initial value, obtained previously of the physical parameters p of the model. This minimisation coefficient may be determined according to the confidence that can be placed in the initial physical parameters pₒ: the more confidence there is in the determination of the initial parameters pₒ, the more this coefficient λ will be high, so as to minimise the variations of physical parameters p during the minimisation step. Thus, this minimisation step will mainly act on the adjustment of calibration factors βij,k. Only the physical parameters p that suffer from imprecision of evaluation are re-evaluated, the physical parameters precisely determined then being fixed. This calculation cannot however be undertaken if there is no calibration peptide; then the coefficients β_{i,j,k} are assumed all equal to 1.

During experiments known as study experiments, in other words enabling the experiments using a sample to be studied, then comprising molecular species of which it is sought to determine the concentrations, a standard known as internal standard is used, in other words present in the sample studied. It generally involves weighted proteins or weighted peptides.

During experiments known as calibration experiments, one or preferably more standards known as external standards are used, in other words different calibration samples of the studied sample in order to enable the identification of parameters of models. These calibration samples comprise molecular species, for example proteins or peptides, the concentration of which is known.

The fact of using an internal standard enables the adjustment of all or part of the coefficients β_{i,j,k} or parameters of the column p, simultaneously to the study of the sample. This is particularly suited when a device known as unstable device is used, in other words for which the coefficients β_{i,j,k} or the parameters p can vary from one experiment to the next. The invention thus makes it possible to estimate parameters specific to the chromatography column (parameters p) as well as the calibration gain for a peptide i (coefficient β_{i,j,k}) simultaneously to the carrying out of measurement experiments, which is one of the advantages of the invention. This is particularly made possible by a representation of the model by a state-space system, the resolution of which enables the estimation of the output function of the system (function y) as a function of the parameters p of the chromatography column.

2) A second step consists in calculating the other calibration coefficients α_{i,k} on the Nc calibration experiments.

$${min}_{{α}_{i , k} , p} {‖ {\sum }_{j = 1}^{Nc} ( {m}_{i , j , k} - {α}_{i , k} {β}_{i , j , k} {y}_{i , k} ( p ) {c}_{j , k} ) ‖}^{2} + λ {‖ p - {p}_{0} ‖}^{2}$$

for i=1 to Nₚₑₚ (all the peptides), the physical parameters p could again be re-evaluated. This calculation cannot however be undertaken if there is no calibration experiment; then the coefficients α_{i,k} are assumed all equal to 1. The coefficient 1 is again a minimisation coefficient, which will be adjusted as a function of the confidence that is placed in the determination of initial parameters pₒ.

3) The final resolution, making it possible to determine the concentrations C_{j,k} of the proteins of study k in the Np study experiments, consists in a new search for a minimum according to

$${min}_{{c}_{j , k}} {‖ {m}_{j , k} - {\sum }_{i = 1}^{Npep} {α}_{i , k} {β}_{i , j , k} {y}_{i , k} ( p ) {c}_{j , k} ‖}^{2}$$

at each experiment j, m_{j,k} representing the sums of m_{i,j,k} as has been seen.

These calculations are easy to carry out on a computer. An example of result obtained is given in FIG. 2, where a modelled signal 5 (y(t)) is superimposed on the signal actually measured 6 after having been weighted by the concentration c and the calibration gains found by the calculation, and also after the re-evaluation of physical parameters p from p₀, which has made it possible to correct failings in the evaluation of the shape (spreading) or the position of the peak in the model 5: the concordance is excellent.

The method described in this application will find application in the analysis of biological fluids and in particular blood. But it could also be used in the characterisation of bacteria by their proteome.

### Other Embodiment of the Invention

### Expression of the Model of the Column

The first order and second order derivatives of the equation (1) encountered above may now be given by the equations (3′) and (4′), instead of (3) and (4):

$$\begin{matrix} \frac{\partial c ( z , t )}{\partial z} {\vert}_{i , n} = \frac{1}{Δ z} [ c ( i , n ) - c ( i - 1 , n ) ] + o ( Δ z ) & ( {3}^{′} ) \\ \frac{{\partial }^{2} c ( z , t )}{\partial {z}^{2}} {\vert}_{i , n} = \frac{1}{Δ {z}^{2}} [ c ( i + 1 , n ) - 2 c ( i , n ) + c ( i - 1 , n ) ] + o ( Δ {z}^{2} ) . & ( {4}^{′} )\end{matrix}$$

It is proposed to use a decentred explicit scheme upstream by approaching the derivative of order 1 in z by an upstream finite difference. This is motivated by the fact that the use of such a scheme makes it possible to relax the stability constraints compared to a centred explicit scheme. The stability constraints being less, the sampling intervals in time Δt and in space Δz could be chosen greater and thus the overall calculation time of the algorithm will be considerably reduced.

The upstream decentred scheme is chosen because the velocity of the solvent uₛ is positive. If this was not the case, a downstream decentred scheme would be chosen, the aim again being going to search for the information by “going against the current”.

The equation (6) is found again

c(i,n+1)=I(p)c(i+1,n)+J(p)c(i,n)+K(p)c(i−1,n) (6),

where nevertheless the coefficients become:

$$I ( p ) = [ \frac{{D}_{i} Δ t}{Δ {z}^{2} ( 1 + Fk )} ] , J ( p ) = [ 1 - \frac{{u}_{s} Δ z Δ t + 2 {D}_{i} Δ t}{Δ {z}^{2} ( 1 + Fk )} ] , \\ K ( p ) = [ \frac{{u}_{s} Δ z Δ t + {D}_{i} Δ t}{ Δ {z}^{2} ( 1 + Fk )} ] ;$$

Instead of equation (12), a slightly modified equation (12′) is arrived at:

$$\begin{matrix}( 1 + {Fk}_{w} {e}^{- S ϕ ( i , n )} ) \frac{1}{Δ t} ( c ( i , n + 1 ) - c ( i , n ) ) - {FSk}_{w} \frac{\partial ϕ ( z , t )}{\partial t} {\vert}_{i , n} {e}^{- S ϕ ( i , n )} c ( i , n ) = - \frac{{u}_{s}}{Δ z} ( c ( i , n ) - c ( i - 1 , n ) ) + \frac{{D}_{i}}{Δ {z}^{2}} ( c ( i + 1 , n ) - 2 c ( i , n ) + c ( i - 1 , n ) ) & ( {12}^{′} ) \\ c ( i , n + 1 ) = Δ {t ( 1 + {Fk}_{w} {e}^{- S ϕ ( i , n )} )}^{- 1} [ \frac{{D}_{i}}{Δ {z}^{2}} ] c ( i + 1 , n ) + Δ {t ( 1 + {Fk}_{w} {e}^{- S ϕ ( i , n )} )}^{- 1} [ \frac{( 1 + {Fk}_{w} {e}^{- S ϕ ( i , n )} )}{Δ t} + {FSk}_{w} \frac{\partial ϕ ( z , t )}{\partial t} {\vert}_{i , n} {e}^{- S ϕ ( i , n )} - \frac{{u}_{s}}{Δ z} - \frac{2 {D}_{i}}{Δ {z}^{2}} ] c ( i , n ) + Δ {t ( 1 + {Fk}_{w} {e}^{- S ϕ ( i , n )} )}^{- 1} [ \frac{ {u}_{ s}}{ Δ z} + \frac{{D}_{i}}{Δ {z}^{2}} ] c ( i - 1 , n ) & \end{matrix}$$

and, in equation (13) identical to that which has already been encountered,

c(i,n+1)=I(i,n,p)c(i+1,n)+J(i,n,p)c(i,n)+K(i,n,p)c(i−1,n) (13)

the coefficients I, J and K are written:

$$I ( i , n , p ) = Δ {t ( 1 + {Fk}_{w} {e}^{- S ϕ ( i , n )} )}^{- 1} [ \frac{{D}_{i}}{Δ {z}^{2}} ] , \\ K ( i , n , p ) = Δ {t ( 1 + {Fk}_{w} {e}^{- S ϕ ( i , n )} )}^{- 1} [ \frac{{u}_{s}}{Δ z} + \frac{{D}_{i}}{Δ {z}^{2}} ] , \\ J ( i , n , p ) = Δ {t ( 1 + {Fk}_{w} {e}^{- S ϕ ( i , n )} )}^{- 1} [ \frac{( 1 + {Fk}_{w} {e}^{- S ϕ ( i , n )} )}{Δ t} + {FSk}_{w} \frac{\partial ϕ ( z , t )}{\partial t} {\vert}_{i , n} {e}^{- S ϕ ( i , n )} - \frac{{u}_{s}}{Δ z} - \frac{2 {D}_{i}}{Δ {z}^{2}} ] .$$

The remainder of the method, and particularly the inversion of the model of the system, is unchanged.

1-21. (canceled)

22. A method for determining concentrations of molecules in a solute of a solution, comprising:
making the solution pass through an instrumentation comprising a chromatographic column and obtaining a chromatogram of the solution;
using a local spatio-temporal model of the transport of molecules through the chromatographic column, to express modelled chromatograms each associated with one of the molecular species, the model being represented in a form of a state-space system; and
performing a numerical inversion operation involving values of the chromatogram of the solution and values of the modelled chromatograms to determine the concentrations.

23. A method for determining concentrations of molecules according to claim 22, wherein the spatio-temporal model of the transport of molecules comprises, for each of the species, an evolution equation of the concentration of the molecules of the species and an interaction equation of the molecules of a mobile phase with a stationary phase.

24. A method for determining concentrations of molecules according to claim 23, wherein the evolution equation expresses the concentration for each point of the chromatographic column as a function of prior concentrations at the point and at neighbouring points, the prior concentrations being weighted by coefficients.

25. A method for determining concentrations of molecules according to claim 24, wherein the coefficients are expressions of parameters comprising parameters of the chromatographic column, parameters of calibrating chromatographic peaks of the species, and adjustment parameters.

26. A method for determining concentrations of molecules according to claim 25, wherein the parameters of the chromatographic column comprise a length and a parameter that is a function of porosity of the column.

27. A method for determining concentrations of molecules according to claim 25, wherein the parameters of calibrating chromatographic peaks comprise a parameter of diffusion of the molecules of the solute.

28. A method for determining concentrations of molecules according to claim 25, wherein the parameters further comprise a parameter linked to a velocity of a solvent in the chromatographic column.

29. A method for determining concentrations of molecules according to claim 25, wherein the adjustment parameters comprise spatial, along the chromatographic column, and temporal sampling intervals.

30. A method for determining concentration of molecules according to claim 25, wherein the parameters further comprise parameters describing a modification of composition of a solvent with time.

31. A method for determining concentrations of molecules according to claim 23, wherein the evolution equation is:
$$\frac{\partial c ( z , t )}{\partial t} + F \frac{\partial q ( z , t )}{\partial t} + {u}_{s} \frac{\partial c ( z , t )}{\partial z} = Di \frac{{\partial }^{2} c ( z , t )}{\partial {z}^{2}}$$

32. A method for determining concentrations of molecules according to claim 24, wherein the transport model is expressed by
$$\{ \begin{matrix}x ( n + 1 ) = A ( p ) x ( n ) + B ( p ) u ( n ) \\ y ( n ) = C ( p ) x ( n ) + D ( p ) u ( n ) \\ x ( 0 ) = {x}_{0} ( p )\end{matrix}$$
where n corresponds to a time sampling from 1 to nt, A is a state matrix, B an input matrix, C an output matrix and D a direct command matrix, A, B, C and D time dependent, and:
$$x ( n ) = ( \begin{matrix}c ( 1 , n ) \\ ⋮ \\ c ( i , n ) \\ ⋮ \\ c ( \frac{L}{Δ z} , n )\end{matrix} )$$
is a column-vector of dimension
$$nz = \frac{L}{Δ Z} ;$$
$$A ( p ) = ( \begin{matrix}J ( p ) & I ( p ) & 0 & & … & & … & & 0 \\ K ( p ) & J ( p ) & I ( p ) & 0 & & & & & \\ 0 & ⋱ & ⋱ & ⋱ & & & & & ⋮ \\ & & ⋱ & ⋱ & ⋱ & & & & \\ ⋮ & & & K ( p ) & J ( p ) & I ( p ) & & & ⋮ \\ & & & & ⋱ & ⋱ & ⋱ & & \\ ⋮ & & & & & ⋱ & ⋱ & ⋱ & 0 \\ & & & & & 0 & K ( p ) & J ( p ) & I ( p ) \\ 0 & & … & & … & & 0 & K ( p ) & J ( p )\end{matrix} )$$
is a square matrix of dimension nz;
$$B ( p ) = ( \begin{matrix}1 \\ 0 \\ ⋮ \\ 0\end{matrix} )$$
is a column-vector of dimension nz; C(p)=(0 . . . 0 1) is a line-vector of dimension nz, with
$$y ( n ) = c ( \frac{L}{Δ z} , n ) ;$$
D(p) is chosen at will, and I(i),J(n) and K(p) are coefficients.

33. A method for determining concentrations of molecules according to claim 33, wherein:
$$I ( p ) = [ \frac{Δ t ( 2 {D}_{i} - {u}_{s} Δ z )}{2 Δ {z}^{2} ( 1 + Fk )} ] , J ( p ) = [ \frac{Δ {z}^{2} ( 1 + Fk ) - 2 {D}_{i} Δ t}{Δ {z}^{2} ( 1 + Fk )} ] , \\ K ( p ) = [ \frac{Δ t ( 2 {D}_{i} + {u}_{s} Δ z )}{2 Δ {z}^{2} ( 1 + Fk )} ] .$$
where F is a porosity factor of the chromatographic column, Dᵢ a chromatographic diffusion factor, and Δₜ and Δ_{z} temporal and spatial sampling intervals of the model.

34. A method for determining concentrations of molecules according to claim 30, wherein the transport model is
$$expressed by \{ \begin{matrix}x ( n + 1 ) = A ( n , p ) x ( n ) + B ( n , p ) u ( n ) \\ y ( n ) = C ( n , p ) x ( n ) + D ( n , p ) u ( n ) \\ x ( 0 ) = {x}_{0} ( p )\end{matrix}$$
where n corresponds to a time sampling from 1 to nt, A is a state matrix, B an input matrix, C an output matrix and D a direct command matrix, A, B, C and D time dependent,
$$x ( n ) = ( \begin{matrix}c ( 1 , n ) \\ ⋮ \\ c ( i , n ) \\ ⋮ \\ c ( \frac{L}{Δ z} , n )\end{matrix} )$$
is a column-vector of dimension
$$nz = \frac{L}{Δ Z} ;$$
$$A ( p ) = ( \begin{matrix}J ( 1 , n , p ) & I ( 1 , n , p ) & 0 & & … & & … & & 0 \\ K ( 2 , n , p ) & J ( 2 , n , p ) & I ( 2 , n , p ) & 0 & & & & & \\ 0 & ⋱ & ⋱ & ⋱ & & & & & ⋮ \\ & & ⋱ & ⋱ & ⋱ & & & & \\ ⋮ & & & K ( i , n , p ) & J ( i , n , p ) & I ( i , n , p ) & & & ⋮ \\ & & & & ⋱ & ⋱ & ⋱ & & \\ ⋮ & & & & & ⋱ & ⋱ & ⋱ & 0 \\ & & & & & 0 & K ( nz - 1 , n , p ) & J ( nz - 1 , n , p ) & I ( nz - 1 , n , p ) \\ 0 & & … & & … & & 0 & K ( uz , u , p ) & J ( uz , u , p )\end{matrix} )$$
is a square matrix of dimension nz;
$$B ( p ) = ( \begin{matrix}1 \\ 0 \\ ⋮ \\ 0\end{matrix} )$$
is a column-vector of dimension nz; C(p)=(0 . . . 0 1) is a line-vector of dimension nz, with
$$y ( n ) = c ( \frac{L}{Δ z} , n ) ;$$
D(p) is chosen at will, and I(i,n,p),J(i,n,p) and K(i,n,p) are coefficients.

35. A method for determining concentrations of molecules according to claim 34, wherein:
$$I ( i , n , p ) = Δ {t ( 1 + {Fk}_{w} {e}^{- S ϕ ( i , n )} )}^{- 1} [ \frac{{D}_{i}}{Δ {z}^{2}} - \frac{{u}_{s}}{2 Δ z} ] , \\ K ( i , n , p ) = Δ {t ( 1 + {Fk}_{w} {e}^{- S ϕ ( i , n )} )}^{- 1} [ \frac{{D}_{i}}{Δ {z}^{2}} - \frac{{u}_{s}}{2 Δ z} ] , \\ J ( i , n , p ) = Δ {t ( 1 + {Fk}_{w} {e}^{- S ϕ ( i , n )} )}^{- 1} [ \frac{( 1 + {Fk}_{w} {e}^{- S ϕ ( i , n )} )}{Δ t} + {FSk}_{w} \frac{\partial ϕ ( z , t )}{\partial t} {\vert}_{i , n} {e}^{- S ϕ ( z , t )} - \frac{2 {D}_{i}}{Δ {z}^{2}} ]$$
where F is a porosity parameter of the chromatographic column, k_{w} a retention factor, S a gradient slope, φ a concentration, Dᵢ a chromatographic diffusion factor and Δ_{z} and Δₜ spatial and temporal sampling intervals of the model.

36. A method for determining concentrations of molecules according to claim 25, wherein gain parameters of the instrumentation are deduced by a search for a minimum of a function that is a difference between measured signals for molecules of known concentration and expressions where the gain parameters intervene, the transport model of the molecules, and the known concentrations.

37. A method for determining concentrations of molecules according to claim 22, wherein the concentrations are obtained by a search for a minimum of a function that is a difference between measured signals for the molecules and expressions where the gain parameters intervene, the transport model of the molecules, and the concentrations.

38. A method for determining concentrations of molecules according to claim 36, wherein some of the parameters are re-evaluated during the search for a minimum.

39. A method for determining concentrations of molecules according to any of claim 22, further comprising use of at least one Bayesian type stochastic minimisation algorithm to obtain a fit between the measurements and the model.

40. A method for determining concentrations of molecules according to claim 32, wherein:
$$I ( p ) = [ \frac{{D}_{i} Δ t}{Δ {z}^{2} ( 1 + Fk )} ] , J ( p ) = [ 1 - \frac{{u}_{s} Δ z Δ t + 2 {D}_{i} Δ t}{Δ {z}^{2} ( 1 + Fk )} ] , \\ K ( p ) = [ \frac{{u}_{s} Δ z Δ t + {D}_{i} Δ t}{Δ {z}^{2} ( 1 + Fk )} ] .$$
where F is a porosity factor of the chromatographic column, Dᵢ a chromatographic diffusion factor, and Δₜ and Δ_{z} temporal and spatial sampling intervals of the model.

41. A method for determining concentrations of molecules according to claim 34, wherein:
$$I ( i , n , p ) = Δ {t ( 1 + {Fk}_{w} {e}^{- S ϕ ( i , n )} )}^{- 1} [ \frac{{D}_{i}}{Δ {z}^{2}} ] , \\ K ( i , n , p ) = Δ {t ( 1 + {Fk}_{w} {e}^{- S ϕ ( i , n )} )}^{- 1} [ \frac{{u}_{s}}{Δ z} + \frac{{D}_{i}}{Δ {z}^{2}} ] , \\ J ( i , n , p ) = Δ {t ( 1 + {Fk}_{w} {e}^{- S ϕ ( i , n )} )}^{- 1} [ \frac{( 1 + {Fk}_{w} {e}^{- S ϕ ( i , n )} )}{Δ t} + {FSk}_{w} \frac{\partial ϕ ( z , t )}{\partial t} {\vert}_{i , n} {e}^{- S ϕ ( i , n )} - \frac{{u}_{s}}{Δ z} - \frac{2 {D}_{i}}{Δ {z}^{2}} ]$$
where F is a porosity parameter of the chromatographic column, k_{w} a retention factor, S a gradient slope, φ a concentration, Dᵢ a chromatographic diffusion factor and Δ_{z} and Δₜ spatial and temporal sampling intervals of the model.

42. A method for determining concentrations of molecules according to claim 22, wherein the chromatogram is obtained from a spectrogram.
